(19) United States
(12) Patent Application Publication
(10) Pub. No.: US 2007/0269691 A1
(43) Pub. Date: Nov. 22, 2007

(54) REFORMER WITH OXYGEN SUPPLIER AND FUEL CELL SYSTEM USING THE SAME

(75) Inventor: DAE HO KO, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/745,066

(22) Filed: May 7, 2007

(30) Foreign Application Priority Data
May 17, 2006 (KR) 10-2006-0044124

(51) Int. Cl. H01M 8/18; B01J 19/00

(52) U.S. Cl. 429/20; 422/198

(57) ABSTRACT

A reformer comprises an oxygen supplying unit that supplies oxygen having a high purity, a combustion reacting unit that burns oxygen and a combustible fuel, a reforming reacting unit that converts a hydrogen-containing reforming fuel into a reforming gas comprising molecular hydrogen using heat generated from combustion reacting unit, and a carbon monoxide removing unit that removes carbon monoxide contained reforming gas. Accordingly, the present invention is capable of more rapidly generating hydrogen having a high purity from an initial startup of a fuel cell in a reformer.

### CROSS-REFERENCE TO RELATED APPLICATIONS

This application claims the benefit of Korean Application No. 2006-44124, filed May 17, 2006, in the Korean Intellectual Property Office, the disclosure of which is incorporated herein by reference.

### BACKGROUND OF THE INVENTION

1. Field of the Invention

Aspects of the present invention relate to a reformer with an oxygen supplier and to a fuel cell system using the same. More particularly, aspects of the present invention relate to a reformer with oxygen supplier that supplies hyperbaric oxygen to the combustion reacting unit of the reformer.

2. Description of the Related Art

A fuel cell is a generating system that directly changes chemical energy into electric energy through an electrochemical reaction of hydrogen and oxygen. For the hydrogen, pure hydrogen can directly be supplied to a fuel cell system, or hydrogen can be supplied by reforming hydrogen-containing material such as methanol, ethanol, natural gas, etc. For the oxygen, oxygen contained in air can be used, and the air can be supplied to the fuel cell system by using an air pump, etc.

Fuel cells may be classified into types, such as a polymer electrolyte type and direct methanol type fuel cell, which are actuated at a temperature less than 100° C., a phosphoric acid fuel cell, which is actuated at a temperature around 150˜200° C., a molten carbonate fuel cell, which is actuated at a high temperature of 600˜700° C., a solid oxide fuel cell, which is actuated at a temperature up to more than 1000° C. and so on. These respective fuel cells basically operate by a same principle, but respectively use different materials, contact agents, and electrolyte membranes, etc.

A polymer electrolyte fuel cell utilizes hydrogen-containing a material such as methanol, ethanol and natural gas, etc., as a reforming fuel, and reforms the reforming fuel to generate the hydrogen used to generate electricity. The polymer electrolyte fuel cell has a good output characteristic, a low actuation temperature, a rapid startup and a response characteristic in comparison with other fuel cells. Therefore, polymer electrolyte fuel cells can be used for a wide range of applications such as in vehicles, buildings and portable electronic apparatuses.

The polymer electrolyte fuel cell basically includes an electricity generating unit that generates a predetermined voltage and current through an electrochemical reaction of hydrogen and oxygen, a reformer that generates hydrogen by reforming a reforming fuel, and a fuel container that stores the reforming fuel.

The electricity generating unit includes at least one unit fuel cell that includes an electrolyte membrane electrode assembly. The electricity generating unit can have a stack structure including a plurality of unit fuel cells.

The reformer changes a hydrogen-containing reforming fuel into a reforming gas that primarily comprises hydrogen gas (H₂). The reformer may utilize a reforming catalytic reaction such as, for example, SR (Steam Reforming), POX (Partial Oxidation), or ATR (Autothermal Reaction). The steam reforming reaction provides a high efficiency because the hydrogen gas generated through the steam reforming reaction has a high purity and a low carbon monoxide content.

However, to perform the steam reforming reaction, the reforming catalyst has to be maintained at a high catalytic temperature. Thus, a reformer that performs the steam reforming reaction includes a reforming reaction unit and combustion reacting unit that provides heat to maintain the reforming reaction unit at the required temperature. The combustion reacting unit carries out heating by inflowing and burning combustible fuel together with oxygen and then supplies the generated heat to the reforming reaction unit.

However, heating the reforming reaction unit to the catalytic temperature in an initial startup of a fuel cell takes a considerable amount of time, because the heating value per hour is limited due to the combustion action of the combustible fuel. Because the reaction to reform a reforming fuel into hydrogen and generate hydrogen having a high purity proceeds poorly or not at all if the temperature of the reforming reacting unit is lower than the catalytic temperature, it is difficult or impossible to generate power until the temperature of the reforming reaction unit reaches the catalytic temperature. The need for a sufficient temperature in the reforming reaction unit can be a factor inhibiting the efficient operation of a fuel cell.

### SUMMARY OF THE INVENTION

According to an aspect of the present invention, there is provided a reformer with an oxygen supplier and fuel cell system using the same that reduces the heating time of a reforming reaction unit of a reformer at a desired catalyst temperature.

A reformer in accordance with one embodiment of the present invention comprises an oxygen supplying unit that supplies oxygen having a high purity, that is, having an oxygen volume ration higher than the oxygen volume ratio of air; a combustion reacting unit that burns the oxygen supplied from the oxygen supplying unit and a combustible fuel; a reforming reacting unit that converts a hydrogen-containing reforming fuel into a reforming gas primarily comprising hydrogen using heat generated from the combustion reaction unit; and a carbon monoxide removing unit that removes carbon monoxide contained the reforming gas generated in the reforming reaction unit. As an example, the oxygen supplying unit may be any one of a compressed gas container, a gas separation membrane and a pressure swing adsorption device storing oxygen having a high purity.

As a non-limiting example, the oxygen supplied from the oxygen supplying unit may have purity by volume ratio of 30% through 95.45%. As a non-limiting example, the reforming reaction unit may perform a steam reforming reaction. As a non-limiting example, the carbon monoxide removing unit may include a water gas shift reaction unit that performs a water gas shift reaction and a preferential oxidation reaction unit that performs a preferential oxidation reaction.

According to another aspect of the present invention, there is provided a reformer comprising: a reforming reaction unit that converts a hydrogen-containing reforming fuel into a reforming gas primarily comprising hydrogen; a combustion reaction unit that heats the reforming reaction unit; and an oxygen supplying unit that supplies a gas having an oxygen volume ratio greater than the oxygen volume ratio of air to the combustion reaction unit.

According to another embodiment of the present invention, a fuel cell system comprises an electricity generating unit that generates electricity through an electrochemical reaction using hydrogen and oxygen; a reformer that supplies the hydrogen to the electricity generating unit; an air supplying unit that supplies the oxygen to electricity generating unit; a water container that supplies water to the reformer; and a fuel container that supplies a reforming fuel containing a combustible fuel and hydrogen to the reformer, wherein the reformer comprises an oxygen supplying unit that supplies oxygen having a high purity, a combustion reaction unit that burns the oxygen supplied from the oxygen supplying unit and a combustible fuel, a reforming reaction unit that converts hydrogen-containing reforming fuel into reforming gas primarily comprising hydrogen using heat generated from the combustion reaction unit; and a carbon monoxide removing unit that removes carbon monoxide contained in the reforming gas generated in the reforming reaction unit. As a non-limiting example, the oxygen supplying unit may be any one of a compressed gas container, an oxygen enrichment membrane and a pressure swing adsorption device storing oxygen having a high purity.

As a non-limiting example, the oxygen supplied from the oxygen supplying unit may have a purity by volume ratio of 30% through 95.45%. As a non-limiting example, the reforming reaction unit may perform a steam reforming reaction. As a non-limiting example, the carbon monoxide removing unit may include a water gas shift reaction unit that performs a water gas shift reaction and a preferential oxidation reaction unit that performs a preferential oxidation reaction.

Moreover, the air supplying unit may be an oxygen supplying unit. As a non-limiting example, the reforming fuel and the combustible fuel may be butane or natural gas. As a non-limiting example, the fuel cell system may be a polymer electrolyte membrane fuel cell system.

According to another aspect of the present invention, there is provided a fuel cell system comprising: an electricity generating unit that generates electricity through a electrochemical reaction of hydrogen and oxygen; and a reformer that supplies the hydrogen to the electricity generating unit; wherein the reformer comprises: a reforming reaction unit that converts a hydrogen-containing reforming fuel into a reforming gas primarily comprising hydrogen; a combustion reaction unit that heats the reforming reaction unit; and an oxygen supplying unit that supplies a gas having an oxygen volume ratio greater than the oxygen volume ratio of air to the combustion reaction unit.

According to another aspect of the present invention, there is provided a method of starting up and operating a reformer of a fuel cell system, the reformer comprising a reforming reaction unit that converts a hydrogen-containing reforming fuel into a reforming gas primarily comprising hydrogen and the reforming reaction unit comprising a catalyst having a predetermined catalytic temperature, the method comprising: heating the reformer to the catalytic temperature by burning a combustible fuel and oxygen supplied in a gas having an oxygen volume ratio greater than the oxygen volume ratio of air in a combustion reaction unit, wherein the combustion reaction unit transmits heat to the reforming reaction unit.

Additional aspects and/or advantages of the invention will be set forth in part in the description which follows and, in part, will be obvious from the description taken in conjunction with the accompanying drawings, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an outline diagram showing a fuel cell system using a reformer according to an embodiment of the present invention; and

FIG. 2 is an outline diagram showing a modified example of a fuel cell system according to another embodiment of the present invention.

The particular embodiments described herein are given for the purpose of illustration only and are not intended to limit the scope of this invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

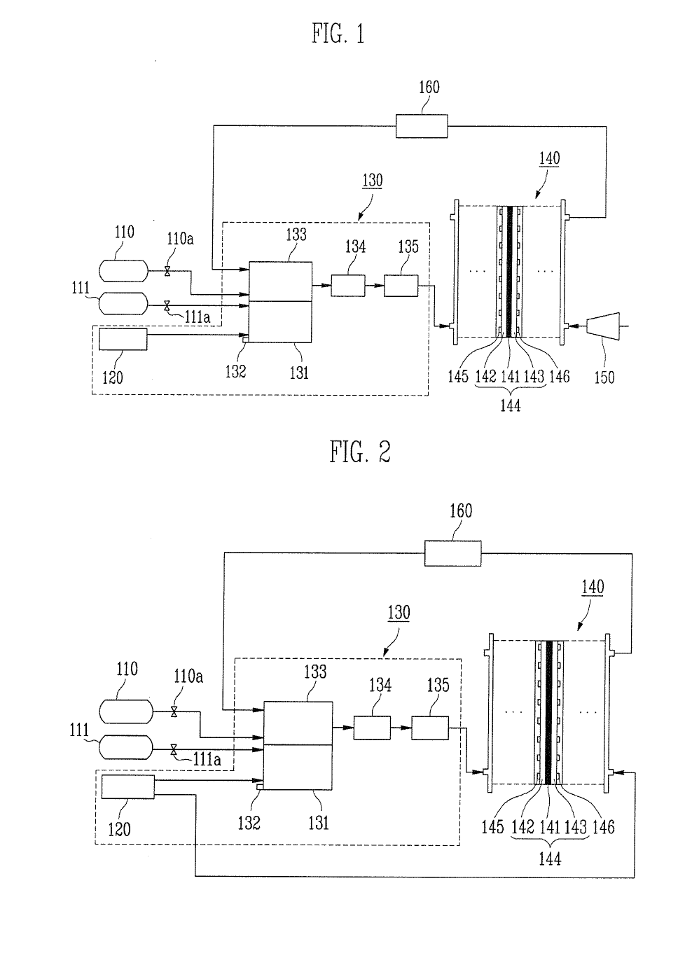

FIG. 1 is an outline diagram showing a fuel cell system using a reformer 130 in accordance with an embodiment of the present invention.

The term “hydrogen-containing reforming fuel” as used herein refers to a fuel that contains hydrogen substituents as part of its molecular structure and that is reformed to produce molecular hydrogen (H₂) through reforming action using a catalyst. For example, the reforming fuel may be methanol, ethanol and natural gas, etc. The term “combustible fuel” refers to an inflammable fuel that supplies heat to the reformer through the heating action of combustion. For example, the combustible fuel may be methanol, ethanol, natural gas, etc.

Referring to FIG. 1, the fuel cell system in accordance with aspects of the present invention comprises a reforming fuel container 110, a combustible fuel container 111, a reformer 130, an electricity generating unit 140, an air supplying unit 150 and a water container 160. In more detail, the reformer 130 comprises an oxygen supplying unit 120, a combustion reaction unit 131, an igniter 132, a reforming reaction unit 133, a water gas shift reaction unit 134 and a selective oxidation unit 135.

A fuel cell system in accordance with aspects of the present invention, such as, for example a polymer electrolyte fuel cell, generates (produces) hydrogen from the reforming fuel in the reformer 130, and generates electricity through the electrochemical reaction of hydrogen and oxygen in the electric generating unit 140.

Water stored in the water container 160 and reforming fuel stored in the reforming fuel container 110 are supplied to the reforming reaction unit 133 of the reformer 130. The reforming fuel container 110 may be a sealed type compressed gas container having an internal pressure. The water stored in the water container 160 can be supplied by using the driving force of a pump (not shown), and the reforming fuel stored at the reforming fuel container 110 can be supplied by adjusting the opening of a first valve 110a. A reforming catalyst, such as, for example, nickel, ruthenium or rhodium, etc., can be contained inside of the reforming reaction unit 133, but the reforming catalyst is not limited to these. The reforming reaction unit 133 changes the reforming fuel mixed with water into a reforming gas having hydrogen as a principal component through a steam reforming reaction using the reforming catalyst. As an example, when the reforming fuel is butane, the steam reforming reaction equation is expressed by the following reaction equation 1.

Steam reforming reaction: C₄H₁₀+8H₂O→4CO₂+13H₂ ΔH298=485.3 KJ/mol [Reaction equation 1]

The combustion reaction unit 131 is installed at one side of the reforming reaction unit 133 of the reformer 130. The combustible fuel stored in combustible fuel container 111 is supplied to the combustion reaction unit 131, and can be supplied by adjusting the opening of a second valve 111a. The combustible fuel container 111 is a sealed type compressed container having an internal pressure. In addition, oxygen having a high purity and used as an oxidizing agent is supplied to the combustion reaction unit 131 from the oxygen supplying unit 120. As used herein, the term “oxygen having a high purity” refers to a gas in which the oxygen content is greater than that of common air. For example, the gas supplied from the oxygen supplying unit 120 may have an oxygen content by volume ratio of 30˜95.45%. As a specific, non-limiting example, the gas may have an oxygen ratio by volume of more than 90%. The oxygen supplying unit 120 can be a compressed gas container storing compressed oxygen having a high purity or can be a high purity oxygen producing device that uses a gas separation membrane or pressure swing absorption to produce oxygen having a high purity. However, the oxygen supplying unit 120 is not limited to these examples. The combustion reaction unit 131 generates heat through a combustion reaction of the combustible fuel and the supplied oxygen, and then supplies the heat to the reforming reaction unit 133 (installed near the combustion reacting unit 131) to provide a catalytic temperature of 500˜700° C. for performing the steam reforming reaction in the reforming reaction unit 131. As an example, when the combustible fuel is methane, the combustion reaction equation is expressed by the following reaction equation 2.

Methane combustion reaction: CH₄+2O₂→CO₂+2H₂O [Reaction equation 2]

The annihilation rate of methane and oxygen in the combustion reaction is expressed by the following reaction equation 3.

Annihilation rate of methane: d[CH₄]/dt=−k[CH₄][O₂]²

Annihilation rate of oxygen: d[O₂]/dt=−2k[CH₄][O₂]² [Reaction equation 3]

According to the reaction equation 3, if the density of oxygen [O₂] increases, the annihilation rate of methane and oxygen increases and thus combustion rate of methane accelerates. Acceleration of the combustion rate of methane means that the quantity of heat generated per unit hour increases. Therefore, if oxygen having a higher purity is used to burn methane, the time required heating the reforming reaction unit 133 to the catalytic temperature can be reduced in comparison with using oxygen contained in a common air.

Carbon monoxide is typically contained in the reforming gas generated in the reforming reaction unit 133 as an undesired byproduct. If this carbon monoxide were allowed to flow into the electricity generating unit 140, the efficiency of the fuel cell system would decline because of poisoning of the catalyst of the electricity generating unit 140. Therefore, the reformer 130 further comprises a water gas shift reaction unit 134 to perform a catalytic water gas shift reaction and a selective oxidation unit 135 (which may also be referred to as a preferential oxidation unit) to perform a selective or preferential oxidation catalytic reaction to remove carbon monoxide. -A copper-zinc base catalyst can be contained inside of the water gas shift reaction unit 134 and a platinum or ruthenium base catalyst can be contained inside of the selective oxidation unit 135, but the shift reaction catalysts and the selective oxidation catalysts are not limited to these examples. The reforming gas generated at the reforming reaction unit 133 is transferred to the water gas shift reaction unit 134, and carbon monoxide contained at the reforming gas is catalytically reduced through the water gas shift reaction in the water gas shift reaction unit 134. Then, the reforming gas reduced in the water gas shift reaction unit 134 is transferred to the selective oxidation unit 135. Residual carbon monoxide in the reforming gas is secondly reduced through a selective oxidation reaction using the catalyst in the selective oxidation unit 135. In the selective oxidation unit 135, oxygen required in the selection oxidation catalytic reaction can be supplied by an air pump (not shown). The selective oxidation unit 135 can be eliminated if the content of residual carbon monoxide of the reforming gas that has been reduced in the water gas shift reaction unit 134 has a low value. The water gas shift reaction and the selective oxidation reaction are expressed by the following reaction equations 4 and 5.

Water gas shift reaction: CO+H₂O→CO₂+H₂ ΔH298=−41.1 KJ/mol. [Reaction equation 4]

Selective oxidation reaction: CO+½O₂→CO₂ ΔH298=−284.1 KJ/mol [Reaction equation 5]

The electricity generating unit 140 generates electric energy through an electrochemical reaction using hydrogen reformed through the reformer 130 and oxygen contained in a common air inflowing through the air supplying unit 150. The electricity generating unit 140 can comprise an electrolyte membrane-electrode assembly 144 that oxidizes/deoxidizes hydrogen and oxygen, a disconnection plate 145 and 146 that supplies the hydrogen and the oxygen to the electrolyte membrane-electrode assembly 144, exhausting its products and electrically serially joining a plurality of electrolyte membrane-electrode assemblies 144. The electrolyte membrane-electrode assembly 144 can have an electrolyte membrane-electrode assembly including an electrolyte membrane 141 interfaced between an anode electrode 142 and a cathode electrode 143, which are formed on either side of the electrolyte membrane 141. The electrochemical reactions of the anode and cathode of the electricity generating unit 140 are expressed by the following reaction equation 6.

Anode electrode: H₂→2H⁺+2e⁻

Cathode electrode: ½O₂+2H⁺+2e⁻→H₂O

Total reaction equation: H₂+½O₂→H₂O+current+heat [Reaction equation 6]

Referring to the reaction equation 6, hydrogen molecules divided into hydrogen ions and electrons at the anode electrode 142, and the hydrogen ions generated at the anode electrode 142 are transferred at the cathode electrode 143 through the electrolyte membrane 141. The hydrogen ions react with oxygen at the cathode electrode 143 to form water, and the electrons generated at the cathode electrode 143 are transferred through an external circuit together as a result of the free energy change of the chemical reaction.

Water generated at the cathode electrode 143 of the electricity generating unit 140 is supplied to the water container 160. Because the water generated at the electric generating unit 140 has a high temperature, a condenser (not shown) to cool and then condense this water can be added to the front of the water container 160.

FIG. 2 is an outline diagram showing a modified example of a fuel cell system according to an aspect of the present invention.

Referring to FIG. 2, the air supplying unit 150 (see FIG. 1) is eliminated and oxygen having a high purity is supplied to the electric generating unit 140 from the oxygen supplying unit 120. Through this structure, the volume of the electricity generating unit 140 and power actuating the electricity generating unit 140 can be reduced, the reaction efficiency of the anode electrode 142 can be enhanced by supplying oxygen having a high purity at the anode electrode 142 and thus a higher efficient generation can be performed.

Although a few embodiments of the present invention have been shown and described, it would be appreciated by those skilled in the art that changes might be made in this embodiment without departing from the principles and spirit of the invention, the scope of which is defined in the claims and their equivalents.

For example, butane or natural gas can be used simultaneously as both the reforming fuel and the combustible fuel. When butane or natural gas are used as the reforming fuel and the combustible fuel, it is possible to supply the reforming fuel and the combustible fuel without separate fuel supplying device by opening the nozzle of a single fuel container, and it is possible to supply enough heat for the reforming reaction because butane or natural have a high heat of combustion. Furthermore, the volume of the fuel cell system can be reduced because of the use of a simple fuel container.

With a reformer having an oxygen supplier according to aspects of the present invention, and a fuel cell system using the same, it is possible to reduce the time required to heat a reforming reacting unit to a catalyst temperature in an initial startup of a reformer because the heating value generated per unit hour can be augmented. Therefore, it is possible to generate hydrogen having a high purity more rapidly from an initial startup of a fuel cell in a reformer. Thus, actuation efficiency of a fuel cell can highly be enhanced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A reformer comprising:
a reforming reaction unit that converts a hydrogen-containing reforming fuel into a reforming gas primarily comprising hydrogen;
a combustion reaction unit that heats the reforming reaction unit; and
an oxygen supplying unit that supplies a gas having an oxygen volume ratio greater than the oxygen volume ratio of air to the combustion reaction unit.

2. The reformer of claim 1, wherein the oxygen supplying unit is a compressed gas container, a gas separation membrane or a pressure swing adsorption device.

3. The reformer of claim 1, wherein the oxygen supplying unit supplies a gas having an oxygen volume ratio of 30% to 95.45% to the combustion reaction unit.

4. The reformer of claim 1, wherein the oxygen supplying unit supplies a gas having an oxygen volume ratio of more than 90% to the combustion reaction unit.

5. The reformer of claim 1, further comprising a fuel container that supplies a combustible fuel to the combustion reaction unit.

6. The reformer of claim 5, wherein the combustible fuel is identical in composition to the hydrogen-containing reforming fuel and wherein a single fuel container provides the hydrogen-containing reforming fuel to the reforming reaction unit and the combustible fuel to the combustion reaction unit.

7. The reformer of claim 5, wherein the hydrogen-containing reforming fuel and the combustible fuel are butane and/or natural gas.

8. The reformer of claim 1, wherein the reforming reaction unit includes a catalyst having a predetermined catalytic temperature and wherein the combustion reaction unit heats the reforming reaction unit to the catalytic temperature at start-up of the reformer and maintains the reforming reaction unit at or above the catalytic temperature during an operation of the reformer.

9. The reformer of claim 1, further comprising a carbon monoxide removing unit that removes carbon monoxide that is contained in the reforming gas generated in the reforming reaction unit.

10. The reformer of claim 9, wherein the carbon monoxide removing unit includes a water gas shift reaction unit that performs a water gas shift reaction and a preferential oxidation reacting unit that performs a preferential oxidation reaction.

11. A fuel cell system comprising:
an electricity generating unit that generates electricity through an electrochemical reaction using hydrogen and oxygen;
a reformer that supplies the hydrogen to the electricity generating unit;
an air supplying unit that supplies the oxygen to the electricity generating unit;
a water container that supplies water to the reformer; and
a fuel container that supplies a reforming fuel containing a combustible fuel and hydrogen to the reformer,
wherein the reformer comprises an oxygen supplying unit that supplies oxygen having a high purity, a combustion reaction unit that burns the oxygen supplied from the oxygen supplying unit and a combustible fuel, a reforming reaction unit that converts hydrogen-containing reforming fuel into a reforming gas primarily comprising hydrogen using heat generated from the combustion reaction unit; and a carbon monoxide removing unit that removes carbon monoxide contained the reforming gas generated in the reforming reaction unit.

12. The fuel cell system as claimed in claim 11, wherein the oxygen supplying unit is any one of a compressed container, a gas separation membrane and a pressure swing adsorption device storing oxygen having a high purity.

13. The fuel cell system as claimed in claim 11, wherein the oxygen supplied from the oxygen supplying unit has purity by volume ratio of 30% through 99.94%.

14. The fuel cell system as claimed in claim 11, wherein the oxygen supplied from the oxygen supplying unit has a purity by volume ratio more than 90%.

15. The fuel cell system as claimed in claim 11, wherein the reforming reaction unit performs a steam reforming reaction.

16. The fuel cell system as claimed in claim 11, wherein the carbon monoxide removing unit includes a water gas shift reaction unit that performs a water gas shift reaction and a preferential oxidation reaction unit that performs a preferential oxidation reaction.

17. The fuel cell system as claimed in claim 11, wherein the air supplying unit is an oxygen supplying unit.

18. The fuel cell system as claimed in claim 11, wherein the reforming fuel and the combustible fuel are butane or natural gas.

19. The fuel cell system as claimed in claim 11, wherein the fuel cell system is a polymer electrolyte membrane fuel cell system.

20. A fuel cell system comprising:
an electricity generating unit that generates electricity through a electrochemical reaction of hydrogen and oxygen; and
a reformer that supplies the hydrogen to the electricity generating unit;
wherein the reformer comprises:
a reforming reaction unit that converts a hydrogen-containing reforming fuel into a reforming gas primarily comprising hydrogen,
a combustion reaction unit that heats the reforming reaction unit, and
an oxygen supplying unit that supplies a gas having an oxygen volume ratio greater than the oxygen volume ratio of air to the combustion reaction unit.

21. The fuel cell system of claim 20, wherein the oxygen supplying unit is a compressed gas container, a gas separation membrane or a pressure swing adsorption device.

22. The fuel cell system of claim 20, wherein the oxygen supplying unit supplies a gas having an oxygen volume ratio of 30% to 95.45% to the combustion reaction unit.

23. The fuel cell system of claim 20, wherein the oxygen supplying unit supplies a gas having an oxygen volume ratio of more than 90% to the combustion reaction unit.

24. The fuel cell system of claim 20, further comprising a fuel container that supplies a combustible fuel to the combustion reaction unit.

25. The fuel cell system of claim 24, wherein the combustible fuel is identical in composition to the hydrogen-containing reforming fuel and wherein a single fuel container provides the hydrogen-containing reforming fuel to the reforming reaction unit and the combustible fuel to the combustion reaction unit.

26. The fuel cell system of claim 24, wherein the hydrogen-containing reforming fuel and the combustible fuel are butane and/or natural gas.

27. The fuel cell system of claim 20, wherein the reforming reaction unit includes a catalyst having a predetermined catalytic temperature and wherein the combustion reaction unit heats the reforming reaction unit to the catalytic temperature at start-up of the reformer and maintains the reforming reaction unit at or above the catalytic temperature during an operation of the reformer.

28. The fuel cell system of claim 20, wherein the reformer further comprises a carbon monoxide removing unit that removes carbon monoxide that is contained the reforming gas generated in the reforming reaction unit.

29. The fuel cell system of claim 28, wherein the carbon monoxide removing unit includes a water gas shift reaction unit that performs a water gas shift reaction and a preferential oxidation reacting unit that performs a preferential oxidation reaction.

30. The fuel cell system of claim 20, wherein the oxygen supplying unit also supplies oxygen to the electricity generating unit.
